(19) United States
(12) Patent Application Publication
(10) Pub. No.: US 2008/0188154 A1
(43) Pub. Date: Aug. 7, 2008

(54) FILM LAMINATE

(75) Inventors: Terry Leis, Huntington, MA (US); James Forster, Haydenville, MA (US); David Hopkins, Southwick, MA (US)

Correspondence Address: O'SHEA, GETZ & KOSAKOWSKI, P.C., 1500 MAIN ST., SUITE 912, SPRINGFIELD, MA, 01115, US

(73) Assignee: Jen-Coat, Inc., Westfield, MA (US)

(21) Appl. No.: 11/957,763

(22) Filed: Dec. 17, 2007

Related U.S. Application Data
(60) Provisional application No. 60/888,392, filed on Feb. 6, 2007.

(51) Int. Cl. B32B 27/12; B32B 7/12; B32B 5/16

(52) U.S. Cl. 442/181; 428/354; 442/394; 428/323

(57) ABSTRACT

A laminate includes at least one layer of an environmentally degradable film, for example, a polylactide (“PLA”) polymer made from an annually-renewable, readily-available resource such as corn. A second layer may be a substrate made from, for example, paper, woven or non-woven fabrics or metallic foils. The environmentally degradable film and the substrate are adhered to one another using, for example, polymeric extrudates or adhesives such as water-based, hot melt, solvent-based or solvent-less adhesives. The choice of adherent depends on the type of substrate to be laminated to the environmentally degradable film and the desired properties of the resultant composite laminated structure (i.e., “laminate”). Such film laminates find use, for example, in the packaging, envelope, tag and label, forms, commercial publication, and digital print industries. Traditional converting equipment may be used to convert the film laminate into rolls, folio sheets and cut size formats as required.

### PRIORITY INFORMATION

This application claims priority to U.S. Provisional Patent Application No. 60/888,392 filed Feb. 6, 2007, which is hereby incorporated by reference.

### BACKGROUND OF THE INVENTION

The present invention relates to the field of composite laminated structures or laminates, and in particular to a laminate having one or more layers each of an environmentally degradable film and a substrate adhered together.

Laminates or laminar structures find use in various industries, including the packaging, envelope, tag and label, forms, commercial publication, and digital print industries. Heretofore, no laminate has been able to satisfy the needs of the markets related to these various industries with regard to an environmentally-friendly laminate while preserving the desired attributes in areas such as strength, barrier and machinability.

Therefore, there is a need for an improved laminate having at least one layer of an environmentally degradable film made from an annually-renewable, readily-available resource such as corn.

### SUMMARY OF THE INVENTION

Briefly, according to the invention, a laminate includes at least one layer of an environmentally degradable film, preferably comprising a polylactide (“PLA”) polymer made from an annually-renewable, readily-available resource such as vegetable matter, for example, corn. A second layer comprises a substrate such as, for example, paper, woven or non-woven fabrics or metallic foils. The environmentally degradable film and the substrate are adhered to one another using, for example, polymeric extrudates or various types of adhesives such as water-based, hot melt, solvent-based or solvent-less adhesives. The choice of adherent depends on type of substrate to be laminated to the environmentally degradable film and the desired properties of the resultant composite laminated structure (i.e., “film laminate”).

Film laminates of the present invention find use, for example, in the packaging, envelope, tag and label, forms, commercial publication, and digital print industries. Traditional converting equipment may be used to convert the film laminate of the present invention into rolls, folio sheets and cut size formats as required.

The laminate of the present invention has the advantage that the film layer included within the laminate is made from an environmentally degradable, annually-renewable and readily-available material such as corn. Similar products made not in accordance with the present invention would typically have a film layer made from a petroleum-based polymer which is of finite supply and is not renewable, and which is not readily environmentally degradable.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 is a perspective view of a first embodiment of a two-layer film laminate and an adhesive binding the layers according to the invention; and

FIG. 2 is a perspective view of a second embodiment of a three-layer film laminate and an adhesive binding the layers according to the invention.

### DETAILED DESCRIPTION OF THE INVENTION

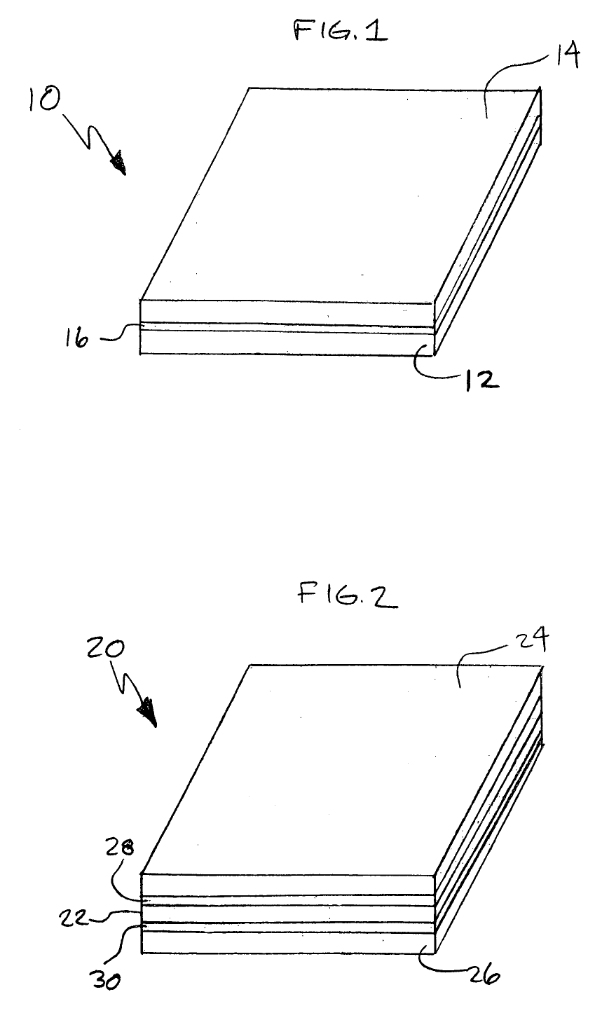

Referring to FIG. 1, a first embodiment of a film laminate 10 according to the invention includes a layer 12 of an environmentally degradable film, preferably a polylactide (“PLA”) polymer derived from vegetable matter (e.g., corn) which by its nature is an annually-renewable and readily-available resource and is not derived from or is independent of petroleum. These types of polymers are environmentally degradable under compost conditions—that is, these polymers are compostable. Thus, materials that utilize PLA polymers are inherently environmentally degradable and use less or no non-renewable resources as compared to conventional petroleum-based polymers which are much less environmentally friendly due primarily to the fact that they are not easily degradable. The film laminate 10 also includes a second layer 14 of a substrate material. Possible materials for the substrate 14 may include, for example, a cellulosic product such as paper including recycled paper. Also, the substrate 14 may comprise, for example, woven fabrics, non-woven fabrics, various non-metallic films, or metallic foils. The PLA film layer 12 and the substrate 14 may be adhered to each other using an adherent layer 16 that may comprise polymeric extrudates, water-based adhesives, hot melt, solvent based adhesives or solvent-less adhesives. The adhesive utilized for the adherent layer 16 depends upon the one or more substrates 14 to be laminated to the PLA film layer 12 and the desired properties of the resultant composite laminated structure 10. A PLA film layer 12 adhered to at least one substrate 14 enhances the properties of the resultant laminate 10.

The adherent layer 16 may comprise an environmentally degradable adhesive such as PLA. Other possible adhesives methods for forming the film laminate 10 of the present invention may include polymer extrusion lamination and other conventional adhesive systems and processes (adhesives such as water-based, solvent-based, hot-melt, solvent-less, etc). The adherent material selected can enhance certain properties of the laminate including but not limited to stiffness, gas permeation barrier, elasticity, toughness, or moisture resistance.

If the substrate 14 comprises paper adhered to the PLA film layer 12 utilizing an environmentally degradable adhesive, the resultant laminate 10 is fully environmentally degradable under compost conditions. That is, the film laminate 10 is fully compostable. Further, if the adherent layer 16 comprises an adhesive made from renewable resources and the substrate layer 14 comprises paper, the laminate 10 is then fully renewable.

The PLA film layer 12 or the substrate 14 may be enhanced through coating of one or both surfaces so that the gas permeability of the laminate 10 is reduced. The coating may comprise liquid applications of polymer or nano-particle dispersions and metallic or silicone oxide deposition. Further, the substrate 14 formed of paper and/or the PLA film layer 12 may be treated to impart moisture resistance and to enhance the durability of the laminate 10. The treatment may be in the form of saturation or surface coating with, e.g., wax, acrylic latex or similar substances.

Referring to FIG. 2, a second embodiment of a film laminate 20 may include a middle layer 22 of, e.g., a PLA film sandwiched between two outer layers 24, 26 of a substrate material, similar to the substrate 14 of the embodiment of FIG. 1. The layers may be adhered together using corresponding layers 28, 30 of an adherent material similar to the adherent layer 16 of FIG. 1. The resulting laminate 20 thus has a paper surface on both sides of the laminate 20. Then, if the adherent layers 28, 30 comprise an environmentally degradable adhesive and the substrate layers 24, 26 comprise paper, the laminate 20 is fully environmentally degradable under compost conditions. Further, if the adherent layers 28, 30 comprise an adhesive made from renewable resources and the substrate layers 24, 26 comprise paper, the laminate 20 is then fully renewable.

As an alternative to the embodiment of FIG. 2, the middle layer 22 may comprise the substrate and the outer two layers 24, 26 may comprise the PLA film adhered together in a similar manner to that described above. The resulting laminate 20 thus has a film surface on both opposing sides thereof. If the substrate 22 comprises, for example, paper, then the laminate 20 is fully environmentally degradable under compost conditions. Further, if the adherent layers 28, 30 comprise an adhesive made from renewable resources and the substrate layer 22 comprises paper, the laminate 20 is then fully renewable.

The laminates 10, 20 of FIGS. 1 and 2 can be converted into rolls, folio sheets and cut size (digital-office-home applications) format by way of conventional converting machinery. Also, the laminates 10, 20 may have the outer surfaces of the substrate or PLA film layer printed with images, data or other information for various applications.

In either of the laminates 10, 20 described above and illustrated herein, different types of cellulose based papers may be used to provide specific performance, print and converting requirements for the packaging, envelope, tag and label, forms, commercial publication, and digital printing industries.

In the embodiments described above where an outer surface of the laminate comprises PLA film, and whereas PLA polymer has a low melt temperature, the laminate can be fused to itself or to another material using heat and pressure, known as heatsealed. This feature allows for the formation and closure of packages without the use of any additional adhesives or sealants. This feature of the invention allows for the benefits of the laminate to be transferred to the finished products.

Although the present invention has been shown and described with respect to several preferred embodiments thereof, various changes, omissions and additions to the form and detail thereof, may be made therein, without departing from the spirit and scope of the invention.

What is claimed is:

1. A composite laminate structure, comprising:
a first layer of a film that comprises a material that is environmentally degradable and annually renewable and is independent of a petroleum-based product;
a second layer that comprises a substrate; and
an adherent layer that binds the first layer and the substrate together.

2. The composite laminate structure of claim 1, where the first layer comprises a polyactide polymer made from vegetable matter.

3. The composite laminate structure of claim 2, where the vegetable matter comprises corn.

4. The composite laminate structure of claim 1, where the substrate comprises a cellulosic product.

5. The composite laminate structure of claim 4, where the cellulosic product comprises paper or recycled paper.

6. The composite laminate structure of claim 1, where the substrate comprises woven fabrics, non-woven fabrics, non-metallic films, or metallic foils.

7. The composite laminate structure of claim 1, where the adherent layer comprises polymeric extrudates, water-based adhesives, hot melt, solvent based adhesives or solvent-less adhesives.

8. The composite laminate structure of claim 1, where one or both surfaces of the first layer are coated with a liquid polymer, nano-particle dispersions, a metallic deposition or a silicone oxide deposition such that a gas permeability of the first layer is reduced.

9. The composite laminate structure of claim 1, where the substrate comprises paper or recycled paper, and the first layer is treated by saturation or surface coating with wax or acrylic latex to impart moisture resistance, reduce gas permeability or improve the durability of the composite laminate structure.

10. The composite laminate structure of claim 1, further comprising:
a second substrate; and
a second adherent layer that binds the first layer and the second substrate together.

11. A multilayered composite laminate structure, comprising:
a substrate layer having first and second opposing surfaces;
a first layer of a film that comprises a material that is environmentally degradable and annually renewable and is independent of a petroleum-based product;
a first adherent layer that binds the first film layer to the first surface of the substrate;
a second layer of a film that comprises a material that is environmentally degradable and annually renewable and is independent of a petroleum-based product; and
a second adherent layer that binds the second film layer to the second surface of the substrate.

12. The multilayered composite laminate structure of claim 11, where the first and second film layers each comprises a polyactide polymer made from vegetable matter.

13. The multilayered composite laminate structure of claim 12, where the vegetable matter comprises corn.

14. The multilayered composite laminate structure of claim 11, where one or both surfaces of each of the first and second film layers are coated with a liquid polymer, nano-particle dispersions, a metallic deposition or a silicone oxide deposition such that a gas permeability of the first and second film layers is reduced.

15. The multilayered composite laminate structure of claim 11, where substrate comprises paper or recycled paper, and the first and second surfaces are treated by saturation or surface coating with wax or acrylic latex to impart moisture resistance, reduce gas permeability or improve the durability of the composite laminate structure.

16. A composite laminate structure, comprising:
a first layer of a film that comprises a material that is environmentally degradable and annually renewable and is independent of a petroleum-based product, where the material of the first layer comprises a polyactide polymer made from vegetable matter;
a substrate that comprises paper or recycled paper, woven fabrics, non-woven fabrics, non-metallic films, or metallic foils; and
an adherent layer that binds the first layer and the substrate together, where the adherent layer comprises polymeric extrudates, water-based adhesives, hot melt, solvent based adhesives or solvent-less adhesives,
where one or both surfaces of the first layer are coated with a liquid polymer, nano-particle dispersions, a metallic deposition or a silicone oxide deposition such that a gas permeability of the first layer is reduced.

17. The composite laminate structure of claim 16, where the vegetable matter comprises corn.
